(19) United States
(12) Patent Application Publication
(10) Pub. No.: US 2014/0081717 A1
(43) Pub. Date: Mar. 20, 2014

(54) METHOD AND SYSTEM FOR ROBUST SOCIAL CHOICES AND VOTE ELICITATION

(71) Applicants: Tian Lu, Toronto (CA); Craig Edgar Boutilier, Toronto (CA)

(72) Inventors: Tian Lu, Toronto (CA); Craig Edgar Boutilier, Toronto (CA)

(21) Appl. No.: 14/001,991

(22) PCT Filed: Mar. 5, 2012
(86) PCT No.: PCT/CA12/00226

§ 371 Date: Nov. 28, 2013

Related U.S. Application Data
(60) Provisional application No. 61/449,272, filed on Mar. 4, 2011.

(51) Int. Cl. G07C 13/00

(52) U.S. Cl. CPC G07C 13/00
USPC 705/12

(57) ABSTRACT

The present invention is a system, method and computer program for generating an optimal decision based on general, incomplete decision-making input, such as incomplete preferences. Input may be provided from a variety of entities (including human and computer entities). The present invention may be operable to utilize such input to make a set of decisions and an optimal decision may be efficiently generated, even if the input represents incomplete voter preferences. The present invention may also undertake a decision-making process that involves a facility to compute minimax regret and to elicit preferences from a voter. Preferences may be elicited by one or more queries posed to a voter about their pairwise preferences in such a way so as to maximally reduce minimax regret. The type of queries and order of queries posed may be determined in accordance with the most efficient decision-making process to arrive efficiently at the optimal decision. In this manner the present invention may guide the decision-making process to support and elicit efficient decision-making.

### FIELD OF INVENTION

This invention relates in general to the field of determining vote results and more particularly to determining vote results based upon incomplete preferences.

### BACKGROUND OF THE INVENTION

Effective schemes for the aggregation of user preferences are critical in settings where a single consensus decision or recommendation must be made for a group of users. Group decision support generally involves finding compromise choices that reflect the consensus opinion or preferences of group members. As applied in the prior art, group decision support is tightly tied to the field of social choice or voting theory, which aims to find a consensus decision through a well-defined mathematical objective, or algorithmic procedure: this objective or procedure takes as its input the given preferences or votes of group members, typically in the form of a ranking over candidates or alternatives, and outputs a suitable consensus alternative that maximizes the objective in question, reflecting some (often implicit) notion of group satisfaction.

Incremental elicitation of preferences is critical to easing cognitive and communication demands on users and mitigating privacy concerns. However, the use of voting schemes to support consensus decision rarely takes this into account. In most schemes, users or voters express their preferences over the space of options or alternatives. The voting scheme then selects a consensus option, or winner. Requiring voters to express full preference orderings can be onerous (especially for large alternative sets) and often captures more information than is needed to determine the winner. Winners can't be determined in many voting schemes without a large amount of information (See: V. Conitzer and T. Sandholm, “Vote elicitation: Complexity and strategy-proofness”, AAAI-02, pp. 392-397, Edmonton, 2002; and V. Conitzer, T. Sandholm, “Communication complexity of common voting rules”, ACM EC'05, pp. 78-87, Vancouver, 2005.)

The relevant prior art includes basic concepts from social choice and several common voting schemes (see W. Gaertner: “A Primer in Social Choice Theory”, Oxford, 2006; and H. Nurmi, “Voting Procedures Under Uncertainty”, Springer, Berlin, 2002, for further background). For example, the prior art assumes a set of agents (or voters) N={1, . . . , n} and a set of alternatives A={a₁, . . . , aₘ}. Alternatives can represent any outcome space over which the voters have preferences (e.g., product configurations, restaurant dishes, candidates for office, public projects, etc.) and for which a single collective choice must be made. Let Γ_{A} be the set of rankings (or votes) over A (i.e., permutations over A). Voter k's preferences are represented by a ranking vₖεΓ_{A}. Let vₖ (a) denote the rank of a in vₖ. Then k prefers aᵢ to aⱼ if vₖ(a)<vₖ(a₁). A collection of votes may be referenced as v=vᵢ, . . . , vₙεΓⁿ_{A} as a preference profile. Let V be the set of all such profiles.

Given a preference profile, the prior art considers the problem of selecting a consensus alternative, requiring the design of a social choice function or voting rule r:V→A which selects a “winner” given voter rankings/votes. Plurality is one of the most common rules: the alternative with the greatest number of “first place votes” wins (various tie-breaking schemes can be adopted). Plurality does not require that voters provide rankings; however, this “elicitation advantage” means that it fails to account for relative voter preferences for any alternative other than its top choice. Other schemes produce winners that are more sensitive to relative preferences, among them:
Positional scoring rules: let α(1), . . . , α(m) score each rank position with α(i)≧α(i+1). The score of alternative a is Sα(a,v)=Σₖα(vₖ(a)). The winner is the a with the greatest score. Borda count is a positional rule with α(i)=m−i. Plurality (α(1)=1,α(i>1)=0), k-approval (α(1, . . . , k)=1,α(k+1, . . . , m)=0, k-veto (α(1, . . . , m−k)=1α(m−k+1, . . . , m)=0 are also positional.
Maxmin fairness: Let s_{f}(α,v)=min {k:m−vₖ(c)}. The winner is the a with maximum score (i.e., the alternative whose worst rank among all voters is highest).
Copeland: Let W(aᵢ, aⱼ; v)=1 if more voters prefer aᵢ to aⱼ, 0.5 if tied, 0 if not. Let s_{c}(aᵢ)=ΣⱼW(aᵢ, a₁). The a with highest score s_{c}(a) wins.
Maximin: Let N(aᵢ, aⱼ; v)=|{vₖ:vₖ(aᵢ)<vₖ(aⱼ)}| be the number of voters who prefer aᵢ to aⱼ. Let sₘ(aᵢ; v)=miniⱼ N(aᵢ, aⱼ). The a with highest score sₘ(a) wins.

Other prior art voting rules also exist (e.g., Bucklin, ranked pairs; and See: L. Xia and V Conitzer, “Determining possible and necessary winners under common voting rules given partial orders”, AAAI-08, pp. 202-207, Chicago, 2008). These prior art voting schemes explicitly score alternatives, implicitly defining “societal utility” for each alternative.

One obstacle to the widespread use of voting schemes that require full rankings is the informational and cognitive burden imposed on voters, and concomitant ballot complexity (and political factors too). This partly explains the popularity of plurality voting in many jurisdictions (See: H. Nurmi, “Voting Procedures Under Uncertainty”, Springer, Berlin, 2002), and the advocacy of more expressive methods (e.g., approval voting. See also: S. Brams and P. Fishburn: “Approval voting”, Amer Pol. Sci. Rev., 72(3):831-847, 1978) that fall short of full ranking. Elicitation of sufficient, but still partial, information about voter rankings could alleviate some of these concerns.

The elicitation question has been studied from a theoretical perspective, addressing whether winners for some voting rules can be determined with incomplete voter preferences (rankings). Unfortunately, worst-case results are generally discouraging. Conitzer and Sandholm demonstrate that the communication complexity of several common voting protocols, such as Borda and Copeland, is O(nm log m), essentially requiring communication of full voter preferences in the worst-case (See: V. Conitzer, T. Sandholm, “Communication complexity of common voting rules”, ACM EC'05, pp. 78-87, Vancouver, 2005). Indeed, determining which votes to elicit to determine a winner is NP-hard in many schemes (e.g., Borda; See: V. Conitzer and T. Sandholm, “Vote elicitation: Complexity and strategy-proofness”, AAAI-02, pp. 392-397, Edmonton, 2002; and J. Lang, “Vote and aggregation in combinatorial domains with structured preferences”, IJCAI-07, pp. 1366-1371, Hyderabad, 2007).

Another related question considered by the prior art is determining necessary and possible winners (See: K. Konczak and J. Lang, “Voting procedures with incomplete preferences”, IJCAI-05 Workshop on Advances in Preference Handling, pp. 124-129, Edinburgh, 2005; J. Lang, “Vote and aggregation in combinatorial domains with structured preferences”, IJCAI-07, pp. 1366-1371, Hyderabad, 2007; and L. Xia and V Conitzer, “Determining possible and necessary winners under common voting rules given partial orders”, AAAI-08, pp. 202-20′7, Chicago, 2008). Despite the theoretical complexity of partial elicitation, practical means of eliciting partial rankings and making decisions with incomplete preferences are vital. The question of effective elicitation of preference information has been addressed recently (see M. Kalech, S. Kraus, G. Kaminka and C. Goldman, “Practical voting rules with partial information”, Journal of Autonomous Agents and Multi-Agent Systems, 22:151-182, 2011). The method described incrementally queries users in an attempt to determine either a necessary winner or to narrow the set of possible winners. These techniques are different from the present invention: (a) In the first scheme described, queries are posed until a necessary winner is determined Unlike the present invention, no approximation is used, and far more information is elicited than is necessary to determine an approximate winner; (b) In the second scheme queries are posed until a fixed number of queries is reached. At that point one possible winner is selected from the range of possible winners. This method, unlike the present invention, provides no means for selecting a winner from the set of possible winners other than randomly, or to present all options to a user and allow them to select one; and it offers no quality guarantees on the group satisfaction or voting score for the selected possible winner. Indeed, as we discuss below, the best guarantee for any possible winner may be considerably worse than those of other alternatives. The present invention is thus not limited to possible winners, which allows it to provide much stronger quality guarantees than if it were restricted to recommending only possible winners.

While social choice theorists have studied such problems for decades, the availability of data about the preferences of millions of individuals afforded by search engines, recommender systems, and related artifacts, has made the practical, computational solution to such problems all the more relevant. In particular, the development of computers and the Internet have enabled convenient, electronic means of submitting votes and the automated implementation of voting protocols so that a consensus decision can be outputted by a computer without human intervention.

Computational implementation of voting rules requires the development of tractable algorithms that can be programmed into a computer. A significant amount of research in computer science and operations research has focused on developing algorithms to implement common voting rules. The prior art reflects that: all existing research that is used to determine winners assumes either that voters provide a complete specification of their preferences (in the form of a ranking, or some information derived from her ranking, such as her most preferred choice, or a set of “approved” choices); or that the voters have provided enough information to unambiguously determine a winner using the voting rule in question. Existing study of voting with incompletely or partially specified rankings from voters has been confined to the question of whether or not a given candidate is the unambiguous winner or a possible winner (given further specification of preferences by the voters).

Besides the sophisticated techniques proposed in the academic literature, there are a variety of computerized services, especially web services that enable group decision making. But in the same way, these existing products require that voter specify their full preference ranking (or else limit expression to “approval” votes). Some of the most relevant prior art services include:

Doodle.com—a web application where event organizers can specify a list of choices, and participants can perform approval voting, where they must specify whether they are “OK” or not “OK” with all options. Then Doodle will simply count the number of “OK”s for each choice and display this to all users.
VoteFair.org—a web application where an election is setup much like Doodle, but voters must give a full ranking over candidates to get sensible results.
Condorcet Internet Voting Service (http://www.cs.cornell.edu/andru/civs.html)—a web application that is similar to VoteFair.org with the exception that voters can express “no opinion” on choices, but this service has no consistent way to handle such “no opinion”, and instead rely on ad-hoc ways to aggregate such preferences.
BetterPolls.com—a web application that has similar functionality to Condorcet Internet Voting Service.
OpenSTV—an open-source software implementation of several commonly used voting rules, including the well-known Single Transferable Vote (STV) method, but it requires that voters specify their full preferences as required by the voting rule in question. Other STV software includes eSTV, Choice Plus Pro. This is not an Internet web application where remote computers can cast votes.
RangeVote.org—a web application that implements the Range Voting rule, where each voter is given 100 points that must be distributed across all candidates. Similar website is www.decing.com.

There are also many scheduling services such as Google™ Calendar, TimeBridge, and Tungle.me that support selection of a common time for meetings. However, usually such prior art services ask if users are available or not and do not support strength of preference over choices. These prior art services are often limited as to choices of time slots, and do not support selection of arbitrary products, information or services.

When these services support incomplete preferences, they have specific ad hoc methods of dealing with them: most commonly, they assume that unranked candidates are placed at the bottom of the ranking.

### SUMMARY OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

In one embodiment of the present invention, there is provided a computer network implemented system for suggesting a group decision, the system, characterized in that the system comprises: (a) one or more server computers, connected to an interconnected network of computers, and linked to a server application; (b) the server application includes or is linked to an intelligent voting manager that: (i) receives as input a plurality of options over which a group of voters have certain preferences (“voter preferences”), and from which one or more options must be selected by the group of voters to establish the group decision; (ii) receives as input information about the voting preferences of one or more voters for one or more of the plurality of options, wherein the voting preferences may relate to (A) all of the possible voting preferences given the plurality of options (“complete preference information”) or (B) a subset of the possible voting preferences given the plurality of options (“partial preference information”, complete preference information or partial preference information being “preference information”), wherein the voter preferences are expressible as pairwise preferences; (iii) is configured to generate one or more suggested group decisions, whether the intelligent voting manager receives complete preference information or partial preference information, the suggested group decisions being generated based on the highest guaranteed level of group decision satisfaction relative to the received complete preference information or partial preference information, using the pairwise preferences; and (iv) initiates the presentation of one or more suggested group decisions as output to the one or more voters.

In yet another embodiment of the present invention, there is provided a system wherein the system is operable to, including through one or more computers systems linked directly or indirectly to the system, (A) generate one or more queries for presentation to the one or more voters, wherein the queries are constructed to elicit preference information, and (B) receive one or more responses to the queries from the one or more voters that include complete preference information or partial preference information.

In a further embodiment of the present invention, there is provided a system wherein the intelligent voting manager is operable to generate one or more quality or group satisfaction guarantees for the one or more suggested group decisions, and initiate the communication of the one or more quality or group satisfaction guarantees to the one or more voters.

In yet a further embodiment of the present invention, there is provided a system wherein the system is operable to receive further preference information from one or more of the voters based on the communication of the one or more quality or group satisfaction guarantees.

In a further embodiment of the present invention, there is provided a system wherein the intelligent voting manager is operable to generate further one or more quality or group satisfaction guarantees based on the preference information including the further preference information, and initiate the communication of the further one or more quality or group satisfaction guarantees to the one or more voters.

In a further embodiment of the present invention, there is provided a system wherein the intelligent voting manager is configured to implement an incremental process wherein the one or more voters iteratively provide further preference information, and receive further quality or group satisfaction guarantees with improved levels as compared to levels associated with quality or group satisfaction guarantees for previously provided preference information, thereby incrementally improving quality or group satisfaction levels with the one or more suggested group decisions.

In yet a further embodiment of the present invention, there is provided a system wherein the system is operable to receive a communication indicating that the one or more voters has accepted one or more suggested group decisions, and upon receipt of the communication the incremental process is concluded and the system is operable to log, or communicate to one or more computer systems linked to the system, the accepted decision.

In a further embodiment of the present invention, there is provided a system wherein preference information, or a subset of preference information, is collected from one or more data sources linked to the system.

In yet a further embodiment of the present invention, there is provided a system wherein the preference information includes preference information both input by the one or more voters and collected from one or more data sources.

In yet a further embodiment of the present invention, there is provided a system wherein the preference information may include preference information extrapolated from one or more of online databases, product review websites, social networking websites, or “check-in” information from one or more location-aware applications or services.

In a further embodiment of the present invention, there is provided a system wherein the incremental process further includes generating queries for one or more data sources linked to the system, and the system is adapted to generate the one or more suggested group decisions including based on the information provided by the one or more data sources in response to the queries.

In yet a further embodiment of the present invention, there is provided a system wherein the one or more suggested group decisions are generated incrementally, the system generating one or more initial suggested group decisions and associated one or more quality or group satisfaction guarantees therewith, and then the system receiving further preference information and based on this further preference information the system generates further suggested group decisions and associated one or more quality or group satisfaction guarantees, where quality or group satisfaction levels of any further suggested group decisions are higher than the quality or group satisfaction levels of preceding suggested group decisions.

In a further embodiment of the present invention, there is provided a system wherein the one or more quality or group satisfaction guarantees are expressed as one or more group satisfaction scores.

In yet a further embodiment of the present invention, there is provided a system wherein the system is operable to generate a plurality of suggested group decisions and the associated group satisfaction score, and initiate the communication of such suggested group decisions and group satisfaction scores to the one or more voters.

In a further embodiment of the present invention, there is provided a system wherein the one or more quality or group satisfaction guarantees are calculated by: (a) measuring group satisfaction for the options using a voting rule that determines a group satisfaction score for each option, based on a ranking of all options by each voter; and (b) determining a guaranteed level of group satisfaction for an option using maximum regret of that option relative to the group satisfaction measurement under (a) above.

In a further embodiment of the present invention, there is provided a system wherein the one or more suggested group decisions are selected from possible group decisions based on the options that either (A) have minimal maximum regret, or (B) have maximum regret that it is within a predetermined factor of the plurality of options having minimal maximum regret.

In yet a further embodiment of the present invention, there is provided a system wherein the intelligent workflow manager is operable to select particular one or more voters for whom if further preference information is obtained the group satisfaction scores can be improved.

In a further embodiment of the present invention, there is provided a system wherein the intelligent workflow manager is further operable to determine particular preference information, which if obtained for one or more voters permits improvement of the group satisfaction scores.

In a further embodiment of the present invention, there is provided a computer implemented method for generating one or more suggested group decisions, characterized in that the method comprises: (a) receiving as input a plurality of options over which a group of voters have certain preferences (“voter preferences”), and from which one or more options must be selected by the group of voters to establish the group decision; (b) receiving input information about the voting preferences of one or more voters for one or more of the plurality of options, wherein the voting preferences may relate to (A) all of the possible voting preferences given the plurality of options (“complete preference information”) or (B) a subset of the possible voting preferences given the plurality of options (“partial preference information”, complete preference information or partial preference information being “preference information”); (c) logging the preference information as a set of pairwise preferences; (d) generating one or more suggested group decisions using the pairwise preferences, whether the intelligent voting manager receives complete preference information or partial preference information, the suggested group decisions being generated based on the highest guaranteed level of group decision satisfaction relative to the received complete preference information or partial preference information; and (e) initiating the presentation of one or more suggested group decisions as output to the one or more voters.

In a further embodiment of the present invention, there is provided a method, comprising the further step of generating one or more quality or group satisfaction guarantees and initiating the communication of these guarantees to the one or more voters.

In another embodiment of the present invention, there is provided a method, wherein the receiving of input information about the voting preferences, and generation of one or more suggested group decisions and related quality or group satisfaction guarantees is an incremental process wherein the quality or group satisfaction guarantees for any subsequent suggested group decisions are improved over quality or group satisfaction guarantees for any previous suggested group decisions.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 shows a partial profile of an embodiment of the present invention where the minimax alternative is not a possible winner.

FIG. 2 shows three possible relations between alternative a and adversarial alternative/witness w in a partial vote p.

FIG. 3a shows a performance of paired and top queries elicitation algorithms of the present invention on Sushi data.

FIG. 3b shows a performance of paired and top queries elicitation algorithms of the present invention on Dublin data.

FIG. 3c shows a performance of paired and top queries elicitation algorithms of the present invention on Mallows data.

FIG. 4 shows a system diagram illustrating the resources of the system of the present invention.

FIG. 5 is a general computer system diagram illustrating a possible implementation of the invention as a computer system, and as a computer program.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

### Definitions

The term “candidate” may generally be understood in this disclosure to refer to any member of the collection of entities over which the group must decide, including situations beyond political elections. These entities may be applied to, but are not limited to, for example the selection of restaurants or dining options for a group; entertainment options (e.g., books, movies, music, concerts, sporting events, theatrical events) for a group; travel options and destinations for a group; corporate decisions on hiring, purchasing, or strategic direction; group buying options where a group may be comparing a variety of purchasing options for which vendors may have offered volume or group discounts, and many others.

It should also be understood that other terms may be used to refer to “candidates” such “options”, “alternatives”, or “choices”. All of these terms may be used interchangeably.

The terms “vote” and “voting” may generally be understood in this document as meaning a process for gathering input such as preferences. Such votes may be elicited directly from the voters or group members themselves; and/or the votes may be extracted directly from various data sources, such as, but not limited to, a database, internet product review sites, online social networking sites, or “check in” data from location-aware mobile applications; or the votes may be determined by some computational processing of said extracted data.

“Voting” in the sense used is not limited to elections but elections are one example of “voting”. The term “voter” may be generally understood to refer to any member of a group who will express his/her preferences over candidates. The users of the computer systems and the computer program may be referred to as “voters”. The term “preferences” refers to any form of ranking of the candidates in question by a voter. This ranking may directly reflect the voter's preferences, or utility the voter derives by seeing that candidate selected for the group (e.g., it may reflect the fact that the voter genuinely prefers to dine at one restaurant over another). This ranking may also reflect a voter's assessment of some objective quality measure or some fact pertaining to the entities in question (e.g., a voter may rank a restaurant based on his or her objective assessment of the amount of business that restaurant engages in, quite independent of his or her preferences for dining at that restaurant). As such, the present invention has application to settings where one wishes to aggregate the opinions of voters in some group rather than their preferences. As such, the application of the present invention to popular systems such as crowdsourcing systems should be evident to those skilled in the art.

It should be understood that given any group of voters, the present invention can be used to select or recommend candidates for any subset of voters within the group, not just the entire group. It will be evident to any person skilled in that how to use the present invention to make decisions for any subgroup (e.g., those in a subgroup that have certain attributes), or compare the decisions of one or more subgroups, given partial information about the preferences of the members of said subgroups.

It should also be understood that in some cases one or more members of the group may in effect delegate their vote to another member. This may occur formally, or it may occur informally for example by virtue of the fact that some members may defer (for example for certain decisions) to other members. Yet a group decision that is acceptable for the entire group is often desired. In fact of the reason for why only partial preference information is available is many situations is this deference to certain group members which may not be explicit.

### Voting Computer System, Method and Computer Program

The present invention is a system, method and computer program for generating an optimal decision based on general, incomplete decision-making input, such as partial preference information. Input may be provided from a variety of entities (including human and computer entities such as software agents, input provided by users using an input means (for example a web page) or online of offline databases, opinion or review sites, or social networking sites).

The system, in one aspect thereof, consists of a decision support computer system and computer program that embodies the methods described herein for aggregating voter preferences in regards to a plurality of options in a way that recognizes the incremental elicitation of voter preferences, and that does not require full expression by users engaging with the system to express their preferences regarding all of the options.

In another aspect of the invention, the system and method enables the use of input from a plurality of users regarding a plurality of possible decisions, to generate an “optimal decision” based on partial information, for example incomplete voter preferences or partial preference information. Significantly, the present invention is operable to adaptively apply one or more techniques to determine group satisfaction in order to derive an optimal decision based on partial information in an efficient manner.

Preferences may be elicited in a number of ways, by one or more queries posed to a voter about their pairwise preferences in such a way so as to maximally reduce minimax regret. The type of queries and order of queries posed may be determined in accordance with the most efficient decision-making process to arrive efficiently at the optimal decision. In this manner the present invention may guide the decision-making process to support and elicit preferences to support efficient decision-making.

In one particular aspect of the invention, it is important to note that the present invention is operable to generate one or more decisions that may be optimal, even if complete preference information is available. What is significant is that in the relatively frequent instances in which complete preference information is unavailable, or is not yet available, the present invention is operable to suggest group decisions that may be optimal with associated quality guarantees. This enables the suggestion of one or more decisions that may be optimal for the group given all of the options based on available preference information that would not permit the suggestion of decisions that may be optimal, based on prior art solutions.

Also, the solution disclosed in this invention, enables the suggestion of an optimal decision based on an incremental process. In one aspect of the invention, the incremental process guides one or more voters toward one or more group decisions that with each successive step approximate the optimal decision more and more.

The computer system may implement a variety of operations (that may be implemented using calculations and algorithms) to undertake a series of steps in order to produce an optimal decision. For example, the computer system may implement one or more operations (by implementing suitable calculations and algorithms) to determine the distance from optimal decision-making at a point in time of the input gathering and thereby determine if more information is required in accordance with one or more decision-making rules.

In one aspect of the invention, a computer network implemented system for suggesting a group decision is provided. The system may be implemented as a decision support system for example, and may also be implemented for example as a web service provided to one or more other system that may benefit from the provision of decision support services supported by the system described.

In on aspect of the invention, the system may be implemented by one or more server computers, connected to an interconnected network of computers, and linked to a server application. The system may also be implemented as part of a cloud service that is part of a cloud computing network.

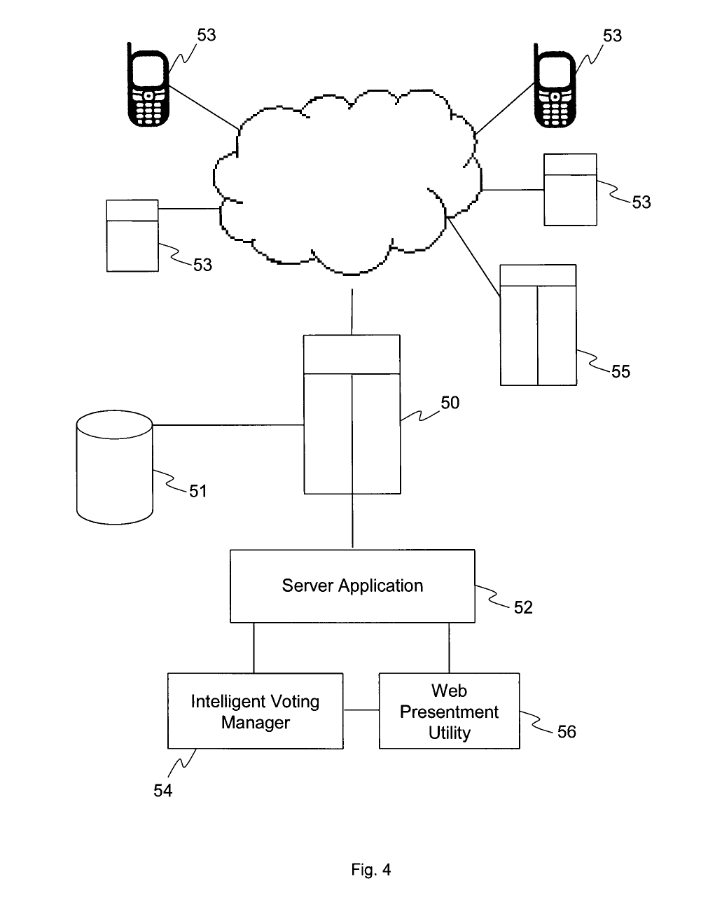

The computer program of the present invention, in one aspect thereof, may be implemented as a server application, whether linked to one or more server computers or to the cloud service. The computer program may also be linked to or integrated with various other platforms or services that may benefit from the decision support operations of the present invention. One example of an implementation of the present invention is shown in FIG. 4.

The present invention may be understood as providing an intelligent voting manager that may be implemented as one or more computer programs, that may be configured in a variety of ways known to those skilled in the art, so as to embody the group decision suggestion operation of described herein.

In one aspect of the present invention, the intelligent voting manager is configured to: (A) receive as input a plurality of options over which a group of voters have certain preferences (“voter preferences”), and from which one or more options must be selected by the group of voters to establish the group decision; (B) receive as input information about the voting preferences of one or more voters for one or more of the plurality of options, wherein the voting preferences may relate to (A) all of the possible voting preferences given the plurality of options (“complete preference information”) or (B) a subset of the possible voting preferences given the plurality of options (“partial preference information”, complete preference information or partial preference information being “preference information”); and (C) generate one or more suggested group decisions, whether the intelligent voting manager receives complete preference information or partial preference information, the suggested group decisions being generated based on the highest guaranteed level of group decision satisfaction relative to the received complete preference information or partial preference information. In a further aspect, the intelligent voting manager is configured to initiate the presentation of one or more suggested group decisions as output to the one or more voters.

In a particular aspect of the invention, the intelligent voting manager is operable to generate described suggested group decisions, including based on partial preference information, provided that the voter preferences may be described as pairwise preferences (as further explained below).

It should be understood that the intelligent voting manager is operable to obtain preference information in response to queries made available to the one or more voters. For example, the intelligent voting manager may generate one or more web pages, or provide information for a third party system to generate one or more web pages, in order to elicit preference information. Alternatively, the intelligent voting manager may connect to one or more data sources supported by computer systems connected to the system of the present invention. Examples of possible data sources are provided in this disclosure. These may include for example one or more of online databases, product review websites, social networking websites, or “check-in” information from one or more location-aware applications or services. In other words the intelligent voting manager may be configured to determine when one or more queries should be constructed for accessing additional preference information from data sources; to construct one or more queries in a format that enables the preference information to be obtained from the data sources; sends the constructed queries to the data sources; receive one or more responses including preference information; and adapts the information in the responses to support the group decision suggestion operations described.

In one implementation, the intelligent voting manager may be configured to invoke the one or more data sources to supplement preference information.

An important advantage of the present invention, is the ability to generate suggested group decisions, as described, based on partial preference information. However, in some instances complete preference information may be available, and the system of the present invention is also configured to generate the suggested group decisions based on complete preference information if that is available.

The intelligent voting manager is operable to generate one or more quality or group satisfaction guarantees for the one or more suggested group decisions, and initiate the communication of the one or more quality or group satisfaction guarantees to the one or more voters.

In another aspect of the invention, the intelligent voting manager is configured to implement an incremental process wherein the one or more voters iteratively provide further preference information (or this is obtained for them from the one or more data sources), and receive further quality or group satisfaction guarantees with improved levels as compared to levels associated with quality or group satisfaction guarantees for previously provided preference information, thereby incrementally improving quality or group satisfaction levels with the one or more suggested group decisions. Furthermore, the intelligent voting manager may be configured to adapt at each increment to the available preference information and generated quality or group satisfaction guarantees to determine one or more strategies for leading the one or more voters to an optimal group decision, or a group decision that is close to optimal.

In some applications the incremental process is followed until “acceptance” of the decision, for example based on input from the one or more voters. In one implementation, the system of the present invention is operable to receive a communication indicating that the one or more voters has accepted one or more suggested group decisions, and upon receipt of the communication the incremental process is concluded and the system is operable to log, or communicate to one or more computer systems linked to the system, the accepted decision.

In another aspect of the invention, the intelligent voting manager is operable to generate a plurality of suggested group decisions, each suggested group decision having a quality or group satisfaction guarantee, and optionally ranking of such suggested group decisions their quality or group satisfaction guarantee. This provides the one or more voters with a range of possible group decisions, the means to compare them to one another, and possibly select the one that best reflects the actual group decision, without the need for complete preference information.

The one or voters may select one particular suggested group decision based on the ranking, or may elect to provide further preference information, resulting in generation of further suggest group decision sets and associated quality guarantees and rankings.

In another aspect of the invention, the one or more quality or group satisfaction guarantees are expressed as one or more group satisfaction scores. The system may generate a plurality of suggested group decisions and the associated group satisfaction scores, and initiate the communication of such suggested group decisions and group satisfaction scores to the one or more voters.

In a particular aspect the one or more quality or group satisfaction guarantees are calculated by: (A) measuring group satisfaction for the options using a voting rule that determines a group satisfaction score for each option, based on a ranking of all options by each voter; and (B) determining a guaranteed level of group satisfaction for an option using maximum regret of that option relative to the group satisfaction measurement under (A) above. The one or more suggested group decisions are selected from possible group decisions based on the options that either (A) have minimal maximum regret, or (B) have maximum regret that it is within a predetermined factor of the plurality of options having minimal maximum regret. In another aspect of the system, the intelligent workflow manager is operable to select particular one or more voters for whom if further preference information is obtained the group satisfaction scores can be improved. In another aspect, the intelligent workflow manager is further operable to determine particular preference information, which if obtained for one or more voters permits improvement of the group satisfaction scores.

In another aspect of the invention, a method is provided, which may be implemented as a computer implemented method, for generating one or more suggested group decisions, characterized in that the method comprises: (A) receiving as input a plurality of options over which a group of voters have certain preferences (“voter preferences”), and from which one or more options must be selected by the group of voters to establish the group decision; (B) receiving input information about the voting preferences of one or more voters for one or more of the plurality of options, wherein the voting preferences may relate to all of the possible voting preferences given the plurality of options (“complete preference information”) or a subset of the possible voting preferences given the plurality of options (“partial preference information”, complete preference information or partial preference information being “preference information”); (C) logging the preference information, optionally as a set of pairwise preferences; and (D) generating one or more suggested group decisions (optionally using the pairwise preferences), whether the intelligent voting manager receives complete preference information or partial preference information, the suggested group decisions being generated based on the highest guaranteed level of group decision satisfaction relative to the received complete preference information or partial preference information.

As a further step, the method includes initiating the presentation of one or more suggested group decisions as output to the one or more voters. The method may include generating one or more quality or group satisfaction guarantees and initiating the communication of these guarantees to the one or more voters.

In another aspect of the method, the method is an incremental process wherein the quality or group satisfaction guarantees for any subsequent suggested group decisions are improved over quality or group satisfaction guarantees for any previous suggested group decisions.

While voting schemes provide an effective means for aggregating preferences, methods for the effective elicitation of voter preferences has received little attention. The present invention addresses this problem by first considering approximate winner determination when incomplete voter preferences are provided. Exploiting natural scoring metrics, in one aspect the system and method uses a max regret step or operation, to measure the quality or robustness of proposed winners. In another aspect of the invention, polynomial time algorithms are applied for establish alternatives by application of minimax regret for several popular voting rules.

One aspect of the contribution of the present invention is the discovery that minimax regret can be used to effectively drive incremental preference/vote elicitation and devise several heuristics for this process. Despite worst-case theoretical results showing that most voting protocols require nearly complete voter preferences to determine winners, the present invention demonstrates the practical effectiveness of regret-based elicitation for determining both approximate and exact winners on several real-world data sets.

While winners can't be determined in many prior art voting schemes without a large amount of information in the worst case, (See: V. Conitzer and T. Sandholm, “Vote elicitation: Complexity and strategy-proofness”, AAAI-02, pp. 392-397, Edmonton, 2002; and V. Conitzer, T. Sandholm, “Communication complexity of common voting rules”, ACM EC'05, pp. 78-87, Vancouver, 2005), the present invention provides significant advantages over the prior art by minimizing the information elicited from voters in practice.

In particular the present invention provides a solution for two key problems. First, the present invention enables the determination in an efficient manner of a suitable approximate winner, using partial information about voter preferences.

It should be understood that in one aspect of the invention, the system and the method of the present invention utilizes informational approximation (cf. existing work on computational approximation of voting schemes focus under conditions of full information). In this sense, the present invention relates to research regarding research on possible and necessary winner determination (See: K. Konczak and J. Lang, “Voting procedures with incomplete preferences”, IJCAI-05 Workshop on Advances in Preference Handling, pp. 124-129, Edinburgh, 2005; J. Lang, “Vote and aggregation in combinatorial domains with structured preferences”, IJCAI-07, pp. 1366-1371, Hyderabad, 2007; and L. Xia and V Conitzer, “Determining possible and necessary winners under common voting rules given partial orders”, AAAI-08, pp. 202-20′7, Chicago, 2008); however, these prior art disclosures do not offer techniques that enable selection of a winning candidate, whereby one may actually choose a winner in settings with incomplete preferences. In one aspect of the invention, a maximum regret operation is used to quantify the worst-case error, the alternatives that minimize the error, thereby providing a form of robust optimization.

In one aspect of the invention, a series of possible methods are provided for computing the minimax-optimal alternatives for providing a selection of voting rules.

In a particular aspect of the invention, the computer system and computer program enable incremental vote elicitation. If the available voter preference information is too limited, the potential error associated with the robust winner (i.e., its max regret) may be unacceptable to a group, a decision making, a company, or an organization utilizing the present invention. As mentioned earlier, in one aspect of the invention, the computer system and method uses the described robust winner determination problem to choose which queries to ask of which voters. In embodiments of the present invention, heuristics that do not require the use of probability distributions or probabilistic information about the preferences of voters may be applied to allow the present invention to determine queries that quickly allow one to reduce minimax regret.

In embodiments of the present invention, elicitation schemes may be provided in accordance with the method described, and extended to exploit preference distribution information.

### System Implementation

In one implementation of the invention the computer system may be implemented for example, as shown in FIG. 4. The computer system may include for example a server computer (50), but may include one or more linked server computers, a distributed computer architecture, or a cloud computing environment. The server computer (50) is linked to a server application (52). The server application (52) includes functionality for enabling the operations described herein. In one aspect of the invention, the server application (52) includes or is linked to an intelligent voting manager (54) that is operable to implement one or more operations that implement the voting method described herein. The server application (52) may include a web presentment utility (56) that is operable to present one or more web pages that include a user interface for enabling voters to provide the input to the voting method, as described. Also, as previously described preference information may be obtained from a variety of data sources, including for example online or offline databases, product review websites, social networking websites, location-aware applications or services, applications (including mobile applications) and so on.

The server application (52), in one implementation, may also include for example one or more filters for detecting if preference information may not be expressed as pairwise preference. Additionally, the server application (52) may include programming that is operable to extrapolate pairwise preferences from preference information provided in other forms. Additional the server application (52) may include logic for generating all of the pairwise preferences that may be implied from particular preference input information.

The server computer (50) is connected to an interconnected network of computers such as the Internet. Voters may connect with the server computer (50) interact with the server application (52) to enable the operations described.

The intelligent voting manager (54) is operable to implement one or more tools for enabling group decision making.

The present invention will allow any group, where this may include, but is not limited to, a formal or informal group, a non-commercial organization, a company or unit within a company, to make group decisions more effectively and with less information about the preferences of group members than required by current state of the art methods and systems. Of particular interest is the fact that, generally speaking, the system of the present invention enables the assembly of a casual group of voters to form a collective decision, where the group generally disperses afterwards. The voters may or may not know one another.

A number of possible applications are described below.

The computer system may be implemented as a web service, where the computer system provides group-decision making which is provisioned to one or more third party systems or platforms.

The intelligent voting manager (54), in one aspect of its implementation embodies a computational framework and associated algorithms that enable groups decisions as described below.

A skilled reader will recognize that there are a variety of implementations of the present invention. The following provides an example of one implementation of the present invention, although other implementations are possible.

In one embodiment of the present invention the implementation may involve a client-server architecture across a computer network. A user, which will be referenced herein as the “event organizer”, may utilize client software, for example, such as a web browser or mobile application, and may request the creation of a group decision problem from a server (e.g. by clicking a webpage button, or through other means). The server may respond with a form to the client. The form may ask for a description of the group decision problem, a list of alternatives from which the group may choose, and a list of group members each with their electronic contact information, for example, such as an email address or social networking identification. In embodiments of the present invention some information may be stored, so related group decision problems may be created without re-specifying all information. The system may also suggest alternatives to the event organizer or other members of the group that may be added to the set of alternatives under consideration by the group. These suggestions may be based on some or all of the preferences either elicited or otherwise predicted for members of the group.

The server may send a message to each group member, for example, such as an email or other type of message. The message may contain instructions providing information including: information about how to access a form to be used for expressing a user's preferences electronically; and about how to reach an information page on the status of the group decision problem. For example, group members may be directed to a web URL address, or may invoke a mobile application on a mobile device (e.g., smart phone) that requests the proper form from the server; or they may be directed to a live “discussion” or chat on a service such as FACEBOOK™ or another social media platform. A skilled reader will recognize that many options of messages, directions, and means of accessing the forms and status information may be included in the present invention.

Each group member may input their preferences through the client software. The preferences may be partial, as long as the partial information can be represented by a set of pairwise comparisons. For example, the users can specify their top three favourite choices, or may simply answer a series of preference queries posed by the system. Then the server may update the preferences and may store the information, for example, such as in a database or other storage means.

The system may re-compute the maximum regret of each choice. The maximum regret of any choice provides a guarantee on the quality of the choice, or its degree of optimality from the perspective of group satisfaction. In other words, if an option or choice C has a maximum regret value of X, then it is guaranteed that, no matter what the complete preferences of group members actually are (consistent with the partial information provided), the optimal choice, i.e., the choice that maximizes group satisfaction, has a group satisfaction level that is no more than X greater than choice C. So if the group were to select choice C, it is assured that it is within a factor of X of being the optimal group choice.

The maximum regret of the choice that has the minimum maximum regret value is called the minimax regret Minimax regret is a very useful progress measure. If minimax regret is zero, the system may tell the event organizer that the optimal decision according to the underlying voting rule has been reached, and that no more preferences from any group member need be inputted to the server. The server may inform each group member that an optimal decision is reached (e.g., through the mobile app, by email, by SMS, etc).

If the minimax regret is greater than zero, then for each group member who has already provided their partial or complete preferences, the server may choose to send that member a message requesting another round of preference input through the elicitation process. This notification may be in the form of an email, SMS, or interaction with a mobile or other live application, etc.

The present invention may incorporate a group decision status page. This status page may show or otherwise display or provide access to a list of alternatives that may be shown along with their max regret values. The minimax regret choice may be highlighted. Additionally, information regarding which group members have provided votes (partial or complete) may be shown.

Additional functionality of embodiments of the present invention may include: allowing group members to modify their votes; allowing the event organizer to add or delete alternatives during the course of an event, or add or delete voters; allowing voters to add alternatives; allowing voters to modify their preferences; allowing automated search for information (e.g., product reviews) for any alternative proposed by the event organizer; allowing chat, discussion, or comments on specific alternatives to be posted by voters; support to connect the event organizer or a designated voter to suitable vendors for the recommended alternative (or some set of alternatives that have proven to have strong group support).

Computational Framework for Making Group Decisions with Incomplete Preferences

The computational framework and associated algorithms that enable group decisions based on incomplete preferences or votes of the present invention may be operable to achieve a quantitative guarantee on the group satisfaction as measured by the particular voting protocol. Such incomplete preferences utilized by the present invention (which may include complete rankings as a special case) may consist of any set of pairwise comparisons between alternatives. As an example, a pairwise comparison may take the form: “alternative A is preferred to alternative B.” As a further example, sets of such comparisons may be used to represent statements such as (or any set thereof): “A is my preferred choice;” “the elements of group X are all preferred to the elements of group Y”; “A is the most preferred item in group X”; “A is the least preferred item in group X”, “My top three choices are A, B and C”; etc.

In one aspect, the calculations or algorithms of the present invention allow voters to express incomplete preferences in the form of one or more arbitrary sets of pairwise comparisons (noting that shorthands such as those mentioned above, for example, such as “A is the preferred item from group X”, may be automatically converted to a collection of pairwise preferences). Given this as input, the present invention may then make, or suggest, a choice of alternatives based on this information. The present invention may thereby provide a voting scheme or set of voting rules to deal in a principled way with partial preferences. A skilled reader will recognize that a variety of voting rules may be utilized in embodiments of the present invention, including known voting rules, for example, such as the well-known Borda count, the plurality rule, the veto rule, the approval rule, the maximin rule, the Bucklin rule, etc.

The present invention may offer a benefit over known prior art, as known prior art is unable to make efficient decisions based upon incomplete preferences and provide any form of quality assurance or robustness guarantee on the quality of a decision. The present invention however may be operable to make decisions with incomplete preferences. Specifically, the present invention may be able to reduce the cognitive and time demands imposed on voters, as insisting on full rankings as is a requirement of the prior art can be time consuming, costly, and cognitively demanding. The present invention may also reduce the number of queries posed (hence, access costs, I/O costs, computation time, and network latency) to data sources that provide direct or indirect information about the preferences of group members. By utilizing the present invention it may be possible in several situations to generate an efficient optimal, or near-optimal choice without obtaining entire complete rankings from one or more voters.

In one aspect of the invention, the first contribution from a voter that may be required by the present invention may be based on the notion of maximum regret. Almost all voting schemes have some way of measuring the “value” of an alternative to a group, given the full preference rankings of the individual voters. The present invention, as it may be given only partial preference information, may define the maximum regret of any alternative to be how far it could be from having the highest value, given any possible completion of the voters' rankings. The “winner” may be defined to be the alternative that has minimum maximum (or minimax) regret. Given partial information about voter preferences, any other alternative may have a lower value than the minimax winner for some completion of voter preferences. Here a completion of a voter's preferences refers to any complete ranking of alternatives that is consistent with the partial preference or ranking information made available to the system. Thus the minimax winner may be the most robust alternative, having the strongest guarantees regarding its value.

For example, the method of the present invention may be used to prove that a particular alternative must be a winner, even in the presence of incomplete voter rankings. For example, if an alternative has minimax regret of zero, then it must win, no matter how much further information voters supply regarding their preferences. One of the outcomes of the present invention is that in a variety of different applications, the computer system and method of the present invention provide such a “guaranteed” winner with very little voter preference data.

The present invention may include algorithms for the efficient computation of the minimax winner for several classes of scoring rules. These may include any positional scoring rules (for example, such as any or a combination of plurality, k-veto, k-approval, and Borda count), maximin fairness and maximin rules. These types of rules may each represent different measures of voter preference, and measures of “value to the group.” The algorithms of the present invention may work for very general forms of “partial preferences” as discussed above.

### Identifying Queries to be Asked to Improve the Quality of the Minimax Winner

The intelligent vote manager may also implement algorithms for identifying which “queries” should be asked to improve the (guaranteed) quality of the minimax winner. If the minimax winner has a regret-level that is sufficiently high, the group may be unsatisfied with the result. This regret may be reduced by selectively asking certain voters for certain additional information about their preferences/ranking. This is further aspect of the adaptive nature of the system and method of the present invention.

The present invention may include algorithms that determine which queries to ask, and which voters to ask these queries of, in order to reduce minimax regret quickly. The present invention may be operable with a variety of different voting rules and measures of values, and can be used to select many different types of queries (e.g., “Do you prefer A to B?”, “What is your 2nd-ranked alternative?”, etc.)

Experiments on real-world data sets have shown that, with the elicitation algorithms of the present invention, good alternatives—or optimal (guaranteed) winners if so desired—may be determined despite asking voters to provide only a tiny fraction of their actual ranking or preference data. In this manner the present invention may provide a benefit over the prior art and in particular may stand in distinction to theoretical results from voting theory that show, in the worst case, one will need to elicit full rankings from all voters for most voting rules. The present invention may thwart and avoid the worst-case of the prior art, by not requiring full ranking from all voters. In this manner, the present invention may have a wider set of applications than prior art solutions in that it is rare that all voters would always provide a full set of rankings as to do so can be time consuming or costly. The present invention may utilize elicitation algorithms that exploit the considerable structure that exists in real-world preferences.

The present invention offers two additional benefits over the prior art, namely robust winner selections even with incomplete voter preferences and the facility to compute minimax regret. Presently, no prior art exists which will allow a group to make a decision with only the partial preferences of the group members with any form of guarantee on the quality or group satisfaction with the said decision (except in the case where the winner is unambiguously determined by the partial preferences). To function with only partial voter preferences known prior art systems and methods must make strong assumptions about the precise nature of those missing preferences. Furthermore, no prior art methods exist that offer a guarantee of how far the value of such a winning candidate (i.e., its group satisfaction score) is from the true best decision, had the full preferences been known. Additionally, no prior art exists which will automatically elicit preferences from a voter by way of a query about their pairwise preferences (or any query that can be represented by a set of pairwise comparisons, e.g., the top k elements of the list, or a choice from a subset of candidates) in such a way so as to maximally reduce minimax regret or improve the quality (or group satisfaction level) of the recommended choice. The present invention overcome these shortcomings of the prior art.

### Implementation

A skilled reader will recognize that the present invention may undertake robust winner selection based on partial profiles in a number of different possible implementations. The following provides examples of possible embodiments of the present invention, although other embodiments may also be possible.

### Robust Winner Selection & Partial Profiles

If only partial information is provided to the computer system of the present invention about the preferences of some or all of the voters, the present invention may assume the partial ranking of a voter k takes a very general form, namely, a partially ordered set over domain A—where A is the set of alternatives from which a group decision must be selected—or equivalently (the transitive closure of) a collection of pairwise comparisons of the form aᵢ>aⱼ. Most natural constraints on preferences, including the responses to natural queries (e.g., pairwise comparison, positional, top-k, and other queries) may be represented in this manner. (One exception involves constraints that are naturally disjunctive, e.g., a response to the question “What alternative is ranked in the k^{th} position?” cannot be mapped to a set of pairwise preferences unless the positions k are queried in ascending or descending order.)

The present invention may let pₖ be the partial ranking or partial vote of voter k, where a partial ranking serves as a representation of any partial preference information made available to the system of the present invention about voter k's preferences for alternatives. This partial ranking may be any complete or incomplete collection of pairwise comparisons between alternatives. It may also be an empty collection, indicating that no information is available about voter k's preferences. A completion of pₖ may be any vote vₖ that extends pₖ, where a vote is any complete ranking of all alternatives that is consistent with the pairwise comparisons contained in pₖ. Let C(pₖ) denote the set of all completions of pₖ, that is, the set of all (complete) votes vₖ that consistently extend pₖ into a complete ranking. The following notation may be introduced: Necₖ(a>b) iff a>b in all completions of pₖ; Posₖ(a>b) iff a>b in some completion of pₖ; and Incₖ(a,b) iff Posₖ(a>b) and Posₖ(b>a). An incomplete profile is a collection of partial votes p=(p₁, . . . , pₙ), with one partial vote for each group member. Let C(p)=C(p₁)× . . . ×C(pₙ) be the set of completions of p. A complete vote profile is any collection v=(v₁, . . . , vₙ) of complete votes, or complete rankings of alternatives, one vote for each group member. Let V denote the set of all possible complete vote profiles, or possible collections of complete preferences for a group.

Let r be a voting rule, which takes as input any (complete) vote profile v and returns a winner or recommended alternative for a group whose complete preferences are represented by that profile. In typical applications of the present invention, while the group members may each have some true underlying complete ranking of the alternatives, they may be unable or unwilling to articulate them completely, or it may be too costly to do so for a specific decision, or the system of the present invention may have access only to partial information about said preferences. Thus, it will be impossible to apply the voting rule r in question with complete confidence in the result. The present invention overcomes this limitation by providing the most accurate result possible, for any given voting rule r, relative to the (possibly) limited information at its disposal.

Possible and necessary winners may be defined as follows (See: K. Konczak and J. Lang. Voting procedures with incomplete preferences. IJCAI-05 Workshop on Advances in Preference Handling, pp. 124-129, Edinburgh, 2005): a is a possible winner under p iff there is some vεC(p) such that r(v)=a; and a is a necessary winner under p iff r(v)=a for all vεC(p). Computationally, the possible winner question may be typically hard (NP-complete), while necessary winner computation can be easy (polynomial time) or difficult (coNP-complete) depending on the voting rule (See: K. Konczak and J. Lang. Voting procedures with incomplete preferences. IJCAI-05 Workshop on Advances in Preference Handling, pp. 124-129, Edinburgh, 2005; and L. Xia and V Conitzer, “Determining possible and necessary winners under common voting rules given partial orders”, AAAI-08, pp. 202-207, Chicago, 2008).

In another aspect of the invention, the existence of a scoring function may be assumed to be s(a,v) that measures the quality of any candidate given a vote (or preference) profile v. Specifically, consider a voting rule r:V→A. A scoring function s may be consistent with rule r iff r(v)εargmax_{aεA} s(a,v) for all vεV. This may be a minimal requirement, since any voting rule may be defined using an indicator function as the score. Many voting rules may be defined using a “natural” score. All rules discussed above have natural scoring functions.

For example, the fact that rules may have natural scoring functions is exploited in the algorithms for necessary winner determination developed in L. Xia and V Conitzer, “Determining possible and necessary winners under common voting rules given partial orders”, AAAI-08, pp. 202-207, Chicago, 2008). The notion of a possible and necessary winners may be generalized when scores are used to allow for ties: a necessary co-winner is a candidate who has a maximum score in all possible completions of a partial profile (e.g., even if the tie-breaking rule used by r goes against it, a is still “as good” a candidate as any winner); possible co-winners are defined similarly in L. Xia and V Conitzer, “Determining possible and necessary winners under common voting rules given partial orders”, AAAI-08, pp. 202-207, Chicago, 2008.

The present invention may have as input a partial profile p and significantly is still operable to make a decision in the face of this incomplete information. (The partial information setting of the present invention is distinguishable from the question of aggregating preferences of voters whose preferences reflect genuine incomparability—See, e.g., M. S. Pini, F. Rossi, K. B. Venable, and T. Walsh, “Aggregating partially ordered preferences”, J. Logic and Comp., 19:475502, 2009). Necessary and possible winners may not resolve this issue satisfactorily because necessary winners often do not exist in the presence of incomplete or partial preference information, and possible winners can only be used to narrow the set of options, not to select a winner with any form of quality guarantee.

There is no prior art that attempts to address the question of suggesting winners regardless of the degree of incompleteness of the votes. Again, the present invention is operable to undertake to suggest winners despite the degree of incompleteness of the votes by utilizing a minimax regret solution concept. This concept has been used for robust decision making, and for driving preference elicitation, in a variety of single-agent domains (See: C. Boutilier. R. Patrascu, P. Poupart, and D. Schuurmans, “Constraint-based optimization and utility elicitation using the minimax decision criterion”, Art. Intel., 170:686-713, 2006; C. Boutilier, T. Sandholm, and R. Shields, “Eliciting Bid Taker Non-price Preferences in (Combinatorial) Auctions”, AAAI-04, pp. 204-211, San Jose, 2004; and D. Braziunas and C. Boutilier, “Assessing regret-based preference elicitation with the UTPREF recommendation system”, ACM EC10, pp. 219-228, Cambridge, Mass., 2010) and in mechanism design (See: N. Hyafil and C. Boutilier, “Mechanism design with partial revelation”, IJCAI-07, pp. 1333-1340, Hyderabad, 2007), but the present invention offers a means of developing a minimax regret solution applicable to voting and (rank-based) social choice and more broadly to any form of group decision making or group recommendation.

The present invention may measure the quality of any proposed winner a given partial profile p by considering how far from optimal a could be in the worst case (i.e., given any completion of p). The minimax optimal solution may be any alternative that is nearest to optimal in the worst case. More formally:

$$\begin{matrix}\begin{matrix}Regret ( a , v ) = {max}_{{a}^{′} ∈ A} s ( {a}^{′} , v ) - s ( a , v ) \\ = s ( r ( v ) , v ) - s ( a , v )\end{matrix} & ( 1 ) \\ PMR ( a , {a}^{′} , p ) = {max}_{v ∈ C ( p )} s ( {a}^{′} , v ) - s ( a , v ) & ( 2 ) \\ \begin{matrix}MR ( a , p ) = {max}_{v ∈ C ( p )} Regret ( a , v ) \\ = {max}_{{a}^{′} ∈ A} PMR ( a , {a}^{′} , p )\end{matrix} & ( 3 ) \\ MMR ( p ) = {min}_{a ∈ A} MR ( a , p ) & ( 4 ) \\ {a}_{p}^{*} ∈ {arg min}_{a ∈ A} MR ( a , p ) & ( 5 )\end{matrix}$$

Regret(a, v) may be the loss (or regret) of selecting a as a winner instead of choosing the optimal alternative under a voting rule r or, equivalently, under the scoring function s, where the voting rule and/or scoring function provide a suitable measure of group satisfaction with any alternative when the group members's true preferences are represented by the vote profile v. (See: W. Smith, “Range voting”, http://www.math.temple.edu/-wds/homepage/rangevote.pdf, 2000.—who uses score-based regret to measure the performance of various voting rules, including range voting, though not in the context of incomplete preference information). In other words, if the group were to choose alternative a (or if a group recommendation system were to recommend decision a to the group) when their preferences are represented by v, then the regret measures the error associated with making the recommendation a rather than making an optimal recommendation.

Regret measures the error of a recommended alternative when the true preferences of each member of the group are completely known. The system of the present invention does not require knowledge of the complete preference profile v, which offers a significant advantage over the prior art. Instead, it may work with access only to a partial profile p. PMR(a, a′, p) denotes the pairwise maximum regret of alternative a relative to another alternative a′ given partial profile p. Specifically, suppose the group is given the choice of choosing between a and a′ (or a recommendation system is able to suggest one of these alternatives). PMR(a, a′, p) represents how much worse a could be for the group than a′ given knowledge of only the partial preference profile p. This simply measures the largest difference in group satisfaction between the two alternatives that could exist given some consistent completion of the group's preferences. Formally, this is the worst-case loss—under all possible realizations of the full profile—of selecting alternative a rather than a′. Notice that pairwise max regret may be negative.

Max regret MR(a, p) may be the worst case loss associated with the group selecting alternative a instead of selecting the optimal alternative, that is, the alternative that maximizes group satisfaction. This may be viewed as adversarial selection of complete profile v, consistent with the known partial profile p, that maximize the loss or regret between the chosen alternative a and the true winner under v. Specifically, suppose a recommendation system suggests alternative a to the group. MR(a, p) represents how much worse a could be for the group than some other (optimal) alternative given knowledge of only the partial preference profile p.

The aim of the present invention may be to choose the alternative a with minimal maximum regret (or minimax regret): MMR(p) may denote minimax regret under partial profile p, while aₚ* may denote the minimax optimal alternative. (This may be informally written as if the optimal candidate is unique, but there can be several alternatives a that minimize max regret.) This may provide a form of robustness in the face of vote uncertainty: every alternative different from aₚ* has worst-case error at least as great as that of aₚ*.

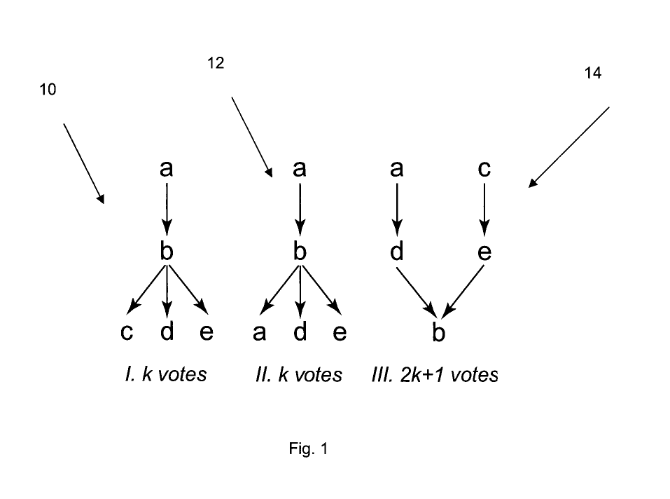

In one embodiment of the present invention if MMR(p)=0, then the minimax winner aₚ* may have the same score or utility as the winner in any completion vεC(p); i.e., aₚ* may be guaranteed to be optimal. While this may not imply that there is a necessary winner under p (due to tie-breaking), MMR(p)=0 iff there is a necessary co-winner. Thus for any rule r it may be possible, by setting ε=0 the profiles shown in FIG. 1.

FIG. 1 shows a partial profile where the minimax alternative is not a possible winner (under the voting rule known as 2-approval). In particular, three sets of partial votes are shown: set I 10 consists of k partial votes; set II 12 consists of k partial votes; and set III 14 consists of 2k+1 partial votes. Alternative b may score 2k in every completion of this collection of partial votes (or partial profile). Either a or c must be at the top of every vote in set III, 14, so one must get at least k+1 points (under the 2-approval rule) from set III. Hence max(s(a), s(c))>2k+1, and a, c may be possible winners, while b may not. Now, MR(b)=k+1 (a completion that puts a at the top of all votes in set III may give a a score of 3k+1, the maximum possible). But MR(a)=2k+1: if a is selected, the adversary may place c and e above a in each vote in set III, setting s(a)=k and s(c)=3k+1. By similar reasoning it may be that MR(c)=2k+1.

In one embodiment of the present invention, the max regret decision problem (i.e., does alternative a have MR(a)≦ε) may be at least as computationally hard as the necessary co-winner problem. This implies minimax regret may be coNP-hard for, say, the Copeland and ranked pairs voting schemes (See: L. Xia and V Conitzer, “Determining possible and necessary winners under common voting rules given partial orders”, AAAI-08, pp. 202-207, Chicago, 2008). It does not imply the easiness of max/minimax regret when the necessary co-winner problem is easy; but the present invention includes polynomial algorithms for computing minimax regret for several important voting rules, including positional rules (of which plurality, approval, veto and Borda rules are examples), maximin, Bucklin, and maxmin fairness. The relationship with possible winners may be more complicated. For certain scoring rules (e.g., plurality) the minimax winner aₚ* must be a possible winner under p.

In another embodiment of the present invention the regret-minimizing alternative may not be a possible winner for some voting rules. FIG. 1 shows this for the 2-approval scoring rule (where the top two candidates in a vote receive a point): both possible winners may have a poor score under some completion of the votes, while a compromise candidate that cannot win may have a higher guaranteed score (i.e., lower max regret) than either possible winner. This demonstrates that using possible winners as a decision criterion with incomplete profiles will generally provide recommended alternatives of winners that have significantly worse quality guarantees (twice as bad in this example) as the alternatives that may be recommended using minimax regret to recommend alternatives, as in the present invention.

### Computing Minimax Regret

In yet another embodiment of the present invention minimax regret may often be solved as a mixed integer program (MIP) (See: C. Boutilier. R. Patrascu, P. Poupart, and D. Schuurmans, ‘Constraint-based optimization and utility elicitation using the minimax decision criterion’, Art. Intel., 170:686-713, 2006; and C. Boutilier, T. Sandholm, and R. Shields, “Eliciting Bid Taker Non-price Preferences in (Combinatorial) Auctions”, AAAI-04, pp. 204-211. San Jose, 2004). In a voting context, a MIP formulation (with variables capturing rank placement in specific votes) would be prohibitively expensive to solve. However, for certain voting rules and preference constraints, minimax regret computation may be greatly simplified by directly considering properties of worse-case completions of voter profiles without directly computing them. Constructions of the present invention may be tightly related to those used by Xia and Conitzer (See: L. Xia and V Conitzer, “Determining possible and necessary winners under common voting rules given partial orders”, AAAI-08, pp. 202-207, Chicago, 2008) to demonstrate polynomial time algorithms for necessary winners for the positional scoring, maximin, and Bucklin rules. Indeed, their constructions may be viewed as attempting to maximize the difference in score between a proposed winner and an “adversarially chosen” alternative. The present invention may utilize similar adapted concepts to minimax regret, and may further generate and apply an analysis of maximin fairness.

As an example, the polynomial time computability of minimax regret may be computed by explicitly computing the pairwise max regret PMR(a, w, p) of all m² pairs of alternatives (a, w) (where a is a proposed winner and w is an adversarial witness). With PMR in hand, minimax regret may be determined using Eqs. 3 and 4, which demonstrates that PMR can be computed in polynomial time.

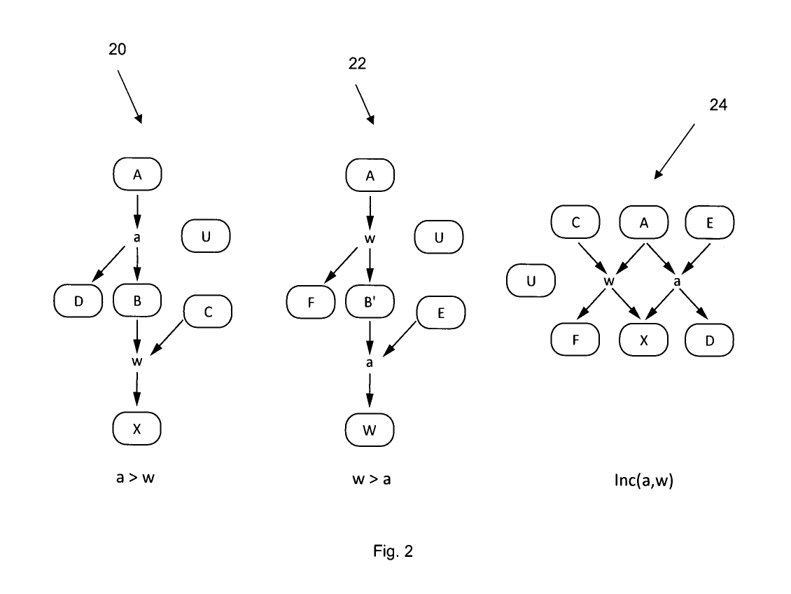

As shown in FIG. 2, three possible relations may exist, as shown as 20, 22 and 24, between alternative a and adversarial alternative/witness w in a partial vote p. To maximize a partial vote's contribution to pairwise max regret PMR(a, w, p), completions of p may require placing the groups of candidates indicated by rectangles in specific positions relative to a and w in a way that depends on the scoring rule.

A scoring rule may be (additively) decomposable if s(a, v)=Σᵢs(a, vᵢ); i.e., it may be the sum of votewise scores. This may imply that regret is decomposable, since

$$\begin{matrix}Regret ( a , w , v ) = s ( w , v ) - s ( a , v ) & ( 6 ) \\ = {\sum }_{i} s ( w , {v}_{i} ) - {\sum }_{i} s ( a , {v}_{i} ) & ( 7 ) \\ = {\sum }_{i} [ s ( w , {v}_{i} ) - s ( a , {v}_{i} ) ] . & ( 8 )\end{matrix}$$

Given a set of partial votes pᵢ, their completions by an adversary can be undertaken independently, so it may be possible to compute PMR by independently choosing completions vᵢ of each pᵢ that maximize vᵢ's local regret:

$$\begin{matrix}PMR ( a , w , p ) = {max}_{v ∈ C ( p )} s ( w , v ) - s ( a , v ) & ( 9 ) \\ = {\sum }_{i} {max}_{{v}_{i} ∈ C ( {p}_{i} )} s ( w , {v}_{i} ) - s ( a , {v}_{i} ) . & ( 10 )\end{matrix}$$

All positional scoring rules may be decomposable in this way.

Constructions of the present invention may be illustrated by first examining the simple case of PMR(a, w, p) for a linear positional scoring rule. (If a positional scoring rule is linear, it implies that an alternative's score is a linear function of its rank in a vote v, hence the difference in two rank positions uniquely determines their difference in score. Veto, approval, and plurality are not linear, but Borda is (linear rules are all “Borda-like”).) Since PMR may be decomposable, it is possible to determine, for any partial vote pᵢ, the completion v, with maximum contribution to PMR. FIG. 2 illustrates three different cases. In the first case 20, the relation Necᵢ(a>w) holds, so pᵢ's contribution to PMR must be negative: it may be possible to maximize regret with a completion vᵢ that minimizes the positional gap between a and w (i.e., maximize the adversary's (negative) advantage). Note that all alternatives may bear one of six distinct relationships to a and w. (A is the set of alternatives (if any) preferred to both a and w; D are those less preferred than a but with unknown relation to w; U have unknown relation to both a and w; etc.) To minimize the gap, it may suffice to order set D below w (arbitrarily), set C above a, and U either above a or below w.

The (negative) contribution to PMR may be exactly—(|B|+1): the present invention may not need to compute an actual completion of pᵢ, but simply determine the size of set B. The case 22 of Necᵢ(w>a) may proceed similarly (see figure), but instead the positional gap between w and a may be maximized by placing sets F, E and U (arbitrarily) between w and a. Hence, the contribution to PMR by pᵢ may be |B′∪F∪E∪U|+1=m−|A∪W|−1. Finally, in the third case 24 of Incᵢ(a, w), positive advantage may be maximized by ordering w over a and placing sets E, F and U between the two. Since the size of the required sets may be computed for a partial vote in polynomial time, PMR(a, w, p) and, hence minimax regret, may be computed in polynomial time for linear scoring rules.

With linear positional rules, arbitrary placement of alternatives that do not influence the positional gap between w and a (i.e., set U when Necᵢ(a>w)) may be allowed. For nonlinear rules, the size of the gap and the position of a, w may influence the advantage. However, the required placement may be found by simply examining splits of set U of different sizes to determine how many to place above a and below w to minimize a's advantage over w; and may be accomplished in polynomial time (See: L. Xia and V Conitzer, “Determining possible and necessary winners under common voting rules given partial orders”, AAAI-08, pp. 202-207, Chicago, 2008). Certain special cases may be treated more efficiently; e.g., if a positional rule is monotonic non-increasing (i.e., sᵢ−sᵢ₊₁≧sᵢ₊₁−sᵢ₊₂) then U may be placed above a (and if non-decreasing, below w).

PMR and minimax regret may be computed using independent completion of partial votes for non-decomposable scoring rules in some cases. Consider maximin fairness, where s(a, v)=minᵢm−vᵢ(a). While minimizing or maximizing the score of a candidate in partial vote pᵢ may be straightforward, the way in which adversarial advantage may be maximized in pᵢ may depend on other votes. In the cases Necᵢ(w>a) and Incᵢ(a, w), there may be only one way to maximize the local advantage of w over a. But when Necᵢ(a>w), the placement of the U either above a or below w may influence the maximin score of a and w in a way that depends on other votes. However, one may show that unless PMR(a, w, p) is negative, then advantage may be maximized by ordering U below w. Informally, placing U below w may improve the min score of both a and w. However, this placement may only improve the min score of a if vote vᵢ gives a its min score over all pᵢ, in which case the min score of w may be strictly less than that of a, and PMR(a, w, p) may be negative. Since max regret may never be negative, the pair (a, w) may not define a's max regret. This may make it possible to prove that, unless PMR is negative, PMR(a, w, p) may be maximized by ordering X below w in any pᵢ where Necᵢ(a>w). This may demonstrate the polynomial time computability of minimax regret for maximin fairness voting.

Finally, the constructions of Xia and Conitzer (See: L. Xia and V Conitzer, “Determining possible and necessary winners under common voting rules given partial orders”, AAAI-08, pp. 202-207, Chicago, 2008) may be used to show the polynomial time computability of minimax regret for the maximin and Bucklin rules. These scoring rules are not decomposable and partial votes cannot be completed independently, so care is required to determine the maximum advantage of w over a.

### Vote Elicitation

A skilled reader will recognize that vote elicitation may be achieved through a variety of methods and systems that are embodiments of the present invention. The following is provided merely as an example of vote elicitation in a particular embodiment of the present invention.

As discussed above, while elicitation may be difficult (w.r.t. computation and communication complexity) in the worst case, minimax regret may be used effectively to guide the elicitation process. As a valuable measure of solution quality, it may be used to terminate elicitation whenever regret falls to some suitable threshold (including zero if optimality is desired). (If determining optimal termination is hard (See: V. Conitzer and T. Sandholm, “Vote elicitation: Complexity and strategy-proofness”, AAAI-02, pp. 392-397, Edmonton, 2002; and T. Walsh, “Complexity of terminating preference elicitation”, AAMAS-08), pp. 967-974, Estoril, PT, 2008), then so may be minimax regret; and conversely, if computing minimax regret is easy (as demonstrated for certain rules above), so may be termination.)

In embodiments of the present invention, the solution to the minimax optimization may guide the selection of queries (and the voters to whom to pose these queries) so that an (approximate or exact) optimal solution may be found quickly. In one embodiment of the present invention a simple heuristic strategy may be utilized to achieve this end. This strategy may utilize linear positional rules (e.g., Borda-like rules) and two specific query types. A skilled reader will recognize that this is but one example of an embodiment of the present invention. Other forms of rules to produce particular queries, such as more generalized rules and other forms of queries, may be utilized by the present invention.

Embodiments of the present invention may apply various forms of queries. For example, a comparison query may be utilized that asks a voter k to compare two alternatives: “Is a [symbol] ₖb”. A top-t query may ask i to state which alternative is t^{th} in their ranking (it may be assumed that the first t−1 alternatives have already been articulated by k). The current solution strategy (CSS) is described in the present disclosure using comparison queries, but the concept of the current solution strategy may be easily adapted to the selection of top-t queries.

The CSS may generate queries by considering the current solution to the minimax optimization—i.e., the minimax optimal alternative a and adversarial witness w—and using this to choose a voter-query pair with greatest potential to reduce minimax regret. Notice that if the advantage of w over a is not reduced in some partial vote pₖ in response to a query, PMR(a, w) will not change, thus, unless the response changes the minimax optimal solution, MMR will not change. So CSS may select queries that tackle this gap directly. The value of posing a query to voter k may be determined by considering the three cases in FIGS. 2, 20, 22 and 24, in each case determining the query with the largest potential reduction given a positive response by k.

As shown in FIG. 2, in the first case 20, a [symbol] w, it may be possible to reduce PMR(a, w) by asking two different types of queries: d [symbol] w for some dεD or a [symbol] c for cεC. In each case a positive response may position alternatives between a and w, reducing PMR(a, w) by increasing the (worst-case) position of a relative to w in partial vote pₖ. We pick the alternative in C∪D (and voter) with greatest potential. If C∪D=0, two other query types may be used, u [symbol] w or a [symbol] u for some uεU. These do not reduce PMR directly, but move u and its ancestors in U to set C (for query u [symbol] w) or u and its descendents to set D (for w [symbol] a). The a with greatest potential to move elements out of set U may be chosen.

As shown in FIG. 2, in the second case 22, w [symbol] a, it may be possible to reduce PMR(a, w) by asking four different types of queries: a [symbol] f for some fεF; a [symbol] u for uεU; e [symbol] w for some eεE; or u [symbol] w for some uεU. A positive response to any such query may reduce PMR by increasing the (worst-case) score of a in pₖ or reducing that of w. Selection may again made by picking the alternative, query and voter with greatest potential reduction.

As shown in FIG. 2, in the second case 22, Inc(a, w), it may be possible to reduce PMR(a, w) by asking several different queries: however, heuristically, the following query may always be asked—if a [symbol] w—since a positive response may reverse pₖ's contribution to PMR from positive to negative. Any response may move partial vote pₖ into either case one 20 or case two 22.

CSS may eventually terminate with an optimal solution.

In one embodiment of the present invention it may be possible that unless MMR=0, CSS may always select a voter k and comparison query aᵢ [symbol] k aⱼ s.t. Incₖ(aᵢ, aⱼ).

If partial vote pₖ meets the third case 24 shown in FIG. 2, this may be obvious. In case onw 20, and case two 22, it may be possible to show that at least one of the designated sets for some voter must be nonempty if MMR>0.

A skilled reader will recognize that CSS may be adapted, using similar intuitions, to generate top-t queries. Here a top-t query refers to asking a voter to provide or list their t^{th}-favorite alternative (where t is some, generally small, integer), asking them in order of rank. Top-t queries may be asked of any voter in order (rank 1 before 2, etc.). As examples of embodiments of the present invention, two other strategies may also be applied. The random strategy (Rand) may be used to randomly choose a voter k and a comparison query s.t. Incₖ(aᵢ, aⱼ) (with top-t queries, Rand may only need to choose k). The volumetric strategy (Vol) may select a voter k and query aᵢ [symbol] aⱼ that maximizes the number of new pairwise preferences revealed (given the worst response)

$$Vol ( {p}_{k} ) = {max}_{{a}_{i} , {a}_{j}} min □ \{ \vert tc ( {p}_{k} ⋃ \{ {a}_{i} ≻ {a}_{j} \} ) \vert , tc ( v ⋃ \{ {a}_{j} ≻ {a}_{i} \} ) \} ,$$

where tc denotes transitive closure. This strategy may reduce preference uncertainty maximally, without regard for “relevance” to winner determination (much like volumetric strategies for single-agent decision making).

### Applications

The present invention may be utilized for a variety of purposes. Voting protocols are not limited to political elections, and in fact, can apply to any activity where agents with potentially conflicting preferences must come to a joint decision.

A skilled reader will recognize that the present invention may have a variety of applications. The following offer some examples of possible applications of embodiments of the present invention, but other applications are also possible.

For example, the present invention may be used by a group of people who need to make a decision, such as what restaurant to go to, where to go on vacation. All of the people may have their preferences regarding these options, and they may or may not agree. The present invention is nonetheless operable to enable an optimal consensus decision.

The present invention may be applied to any consensus decision process such as collaborative decision making, group buying, political polling and so on. Further details are provided below.

As an example, the present invention may be utilized to facilitate the identification of a winner in a political election or to facilitate collaborative selection of a restaurant for a group. In the latter example, a vote may refer to input regarding a preference of restaurant, or supporting information such as a preferred type of food (e.g., Indian, Moroccan, etc.).

One embodiment of the present invention may be applied as a consumer decision support tool. For example, a group of friends or a large extended family may need to decide on a vacation spot from a selection of eight options. Some of the group may prefer relaxing on the beach, some may prefer sightseeing in Europe, and others may prefer trekking through the deserts of Jordan. The present invention may be operable to do one or more of the following: collect (partial) ranked preferences of the members of the group/family, allow discussion of alternatives; identify whose preferences need to be refined to improve decision quality guarantees to a level deemed appropriate by the group; and recommend the top choice. The present invention may allow an organizer to select a specific voting rule if desired, or may default to a specified default rule (e.g., such as a Borda count, or other rule) if no selection is made. The present invention may also link to reviews (for example, such as through Google™ search, connection to various travel web sources or review sites, etc.) to help individual voters form opinions on alternatives with which they are unfamiliar. The present invention may connect the event organizer to specific tour operators or travel web sites to explore bookings once a decision has been reached.

As another example of an application of an embodiment of the present invention, a book club may need to decide on the next book to read next month. In such a setting, creation of a repeated event may allow the re-use of information for (for example, such as, a group member contact/subscriber IDs, previously rejected alternatives and their past scores, etc.) to streamline event creation. The present invention may also incorporate constraints specific to repeated events: for example, the organizer can request that the tool use past votes to ensure that a every member has one of their top-3 choices selected at least once during the course of a certain time period (e.g., once per year). Or the organizer can insist that some “diversity” in theme or topic be enforced among the winners selected in a particular period.

As yet another example of an application of an embodiment of the present invention, a group of co-workers may want to celebrate a product launch by eating out for dinner. They may choose a restaurant together to maximize group satisfaction. In some situations, functionality to support repeated choice as discussed above may be used.

As still another example of an application of an embodiment of the present invention, a group of friends going out to watch a movie may choose among the dozen or so showing in theatres.

When applied as a consumer decision support tool, the present invention may quantify group strength of preference for one or more alternatives and allow vendors of the alternatives in question to offer group discounts in a way that is tailored to the specific group based on their relative strength of preference for the vendor's alternative.

Other embodiments of the present invention may be applied as a tool for political polling and voting. For example, government officials or candidates for office may be interested in conducting surveys of constituents' reaction to budget cuts in various social programs. A social networking application utilizing the present invention may invite constituents to input their votes over importance of different programs, and may focus the attention of constituents on ranking those alternatives that are most promising.

An embodiment of the present invention may be utilized to implement political voting procedures that require voters to provide full rankings. One of the drawbacks of full rankings is the burden imposed on voters, especially in settings where many dozens of candidates need to be ranked. The present invention may be utilized to dynamically determine how “deeply” any specific voter needs to go into their ranking in a way that is sensitive to the preferences of the individual voter and the state of the vote so far.

Yet other embodiments of the present invention may be applied as a corporate decision making tool. For example, most corporate decisions involve making detailed trade-offs among various alternatives, whether those involving long-term strategic plans, acquisitions, and R&D endeavours; or short-term sourcing and procurement decisions. As one simple example, consider sourcing of materials (e.g., drugs or medical-surgical equipment for a hospital chain). Demand aggregation across units (e.g., different doctors or medical units) may suggest that one (or a small number) of alternatives be selected for a specific purpose in order to minimize costs and logistical overhead of ordering. An embodiment of the present invention may be used to intelligently collect preferences over alternative “substitutable” supplies (e.g., drugs) to determine the best collective choice. As above, the present invention may be used to (interactively) determine which preference information is needed from which units in order to determine a suitable organizational buying decision.

The present invention may be used in an entirely analogous way to support the activities of purchasing consortia, e.g., groups of small businesses who band together to aggregate their demand from specific suppliers in order to find group and volume discounting opportunities. As in corporate settings, vendors/suppliers may also use the group strength of preference for their offerings to determine customized discounts.

Consider group buying, for example, of the form practiced by industry-specific buying consortia or broadly based Group Purchasing Organizations (GPOs). A GPO identifies a selection of vendors who are offering volume discounts to a buying group, and the buyers within the group may have preferences over the different “deals” (combinations of vendors and prices solicited by the GPO). Allowing buyers within the GPO to express a partial ranking of deals eases the burden on buyers, by dropping the requirement that the buyers evaluate and compare the offerings of all vendors. Instead, they may focus their attention on only those vendors who are more preferred (e.g., because their products, supplies, or services have specifications that are most closely aligned with the needs of that buyer). At the same time, the robust optimization of the present invention allows buying decisions to be made for the group (with quality guarantees) with this partial ranking information. The incremental elicitation methods of the present invention can be used to identify additional, minimal buyer preference information to improve the quality of the group buying decision.

The present invention may be used to run elections and determine their winners using partial information. The elections in question can be political, but can also be used for more “entertaining” uses, such as People's Choice Awards, All-star, MVP, and Award Voting in professional sports leagues, national rankings of sports teams, etc. The invention may be used for political polling (or even political winner determination): partial ranking of candidates eases burden on voters (they can provide a small set of simple pairwise comparisons of candidates, rank only their top couple of candidates, etc.). Robust optimization allows winner determination (or approximate winner determination) with only partial vote information, including the fact that some voters may not have voted at all. These come with quality guarantees if the winner is not “provably optimal.” The elicitation methods of the present invention can quickly identify which additional voters should provide which additional information to improve quality guarantees with minimal additional information. The present invention supports decisions a priori, on how much information to request to determine a high quality winner with high probability without having to ask any additional questions.

The present invention may be used for voting group segmentation. Specifically, it can be used as part of a larger polling effort designed to segment groups of voters based on their views. The ability to segment voters based on their preferences for policy alternatives also implies that the present invention may also be applied for the purpose of political platform design. For example the system of the present invention may be used as part of a larger system designed to interact with (poll) voters or party members to design a policy package or political platform that will have maximal appeal to some target constituency.

The present invention may be applied in various aspects of marketing. For example in connection with customer surveys, rather than requiring customers to fill out complete preferences of alternatives, the present invention may be used to (a) analyze partial preference ranking data; or (b) control online, interactive surveys, where the current partial ranking information (partial responses) from only a subset of surveyed customers is used, with the robust optimization techniques, to determine the best option (e.g., product design, promotional effort) given the information at hand (together with quality guarantees), and the elicitation methods can be used to identify which additional questions to ask (of specific customers) in order to improve the quality guarantees of the best option.

For market segmentation, the present invention can be used as part of a larger system that segments customers into different categories based on their preferences for products, where the present invention provides the advantage of being able to perform such segmentation with very limited, partial survey data.

The present invention may also be used for targeting offer. For example the system may be used to support the targeting of products, advertising, or promotional offers such as discounts to customers in specific market segments without requiring full survey or preference data from surveyed customers.

In social media applications, the present invention may be used to select options most satisfying to group members. For example the invention may be adapted to support: group social outings (Restaurants, movies, concerts, sports events, recreational activities, etc.); group travel, book club selection, venue selection (e.g., corporate retreats), event planning and scheduling, group movie/music selection, demand aggregation within a social group.

Vendors of products and services typically used by social or formal groups (see example above) benefit from social groups using the present invention: the (partial) preference information provided by the group can be used by vendors to target specific advertising, promotions or discounts to the group. This includes vendors of the “group optimal” decision/product/services, as well as competitors who may offer discounts to sway the group's decision.

This present invention may also be used in various human resources applications. For example, the present invention may be used for hiring decisions. Hiring decisions often involve the deliberations of multiple individuals/stakeholders with different preferences over candidates. The present invention may be used to poll the preferences of stakeholders and make robust hiring recommendations with minimal intrusion/information. One example of large-scale hiring is the National Residency Matching Program (NRMP) in the US which requires hospitals to rank residency candidates across the country. Since the rankings of hospitals reflect the preferences of multiple stakeholders (many doctors and administrators), the present invention may be used directly by a hospital to produce its ranking (over what is a very large group of candidates), and do so in the presence of partial preference information.

The present invention may be used for example for committee selection. The technology of the present invention can be used to find a representative committee reflecting the diversity of preferences of an organization.

The present invention may also be used for group benefit selection. A company may use the present invention to effectively assess the preferences and tradeoffs of its employees for options to include in a benefit plan (e.g., group insurance products, health benefits, pension benefits).

The present invention may also be used in connection with labor negotiations/collective bargaining. For example negotiation teams may use the present technology to efficiently poll their membership to determine demands (and the tradeoffs between them).

The present invention may be used for meeting scheduling, for corporate strategy and policy decisions, and so on. The technology can be used for example to poll more broadly within an organization (e.g., across employees, using corporate social networks, etc.)

In the sales/development domain, the technology may be used for example to poll customers to see which product enhancements (e.g., software features) they would most prefer to see added to their current offerings.

The technology may be used to intelligently determine which questions (e.g., compare two different answers to a question, or which of two different passages best describe an image, etc.) to ask to come up with a high quality answer with the fewest queries (hence at the least cost)

### Examples in Operation

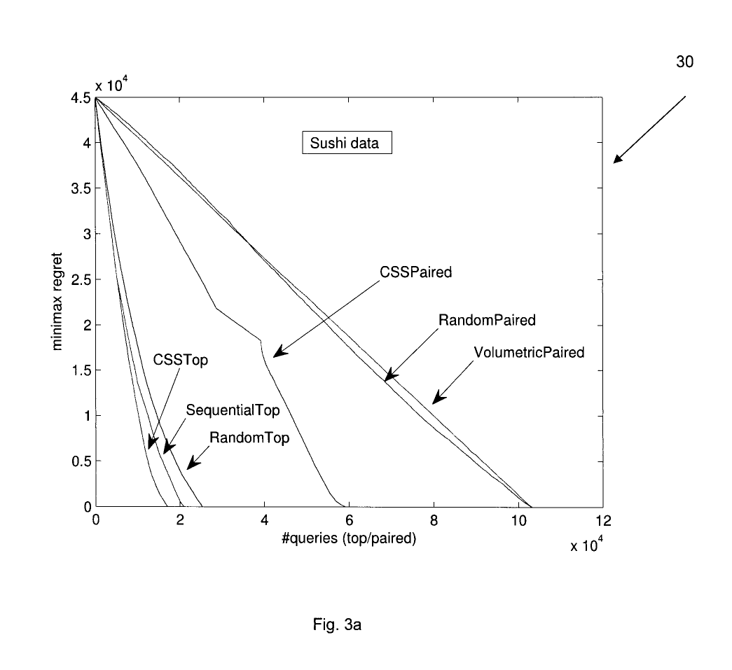

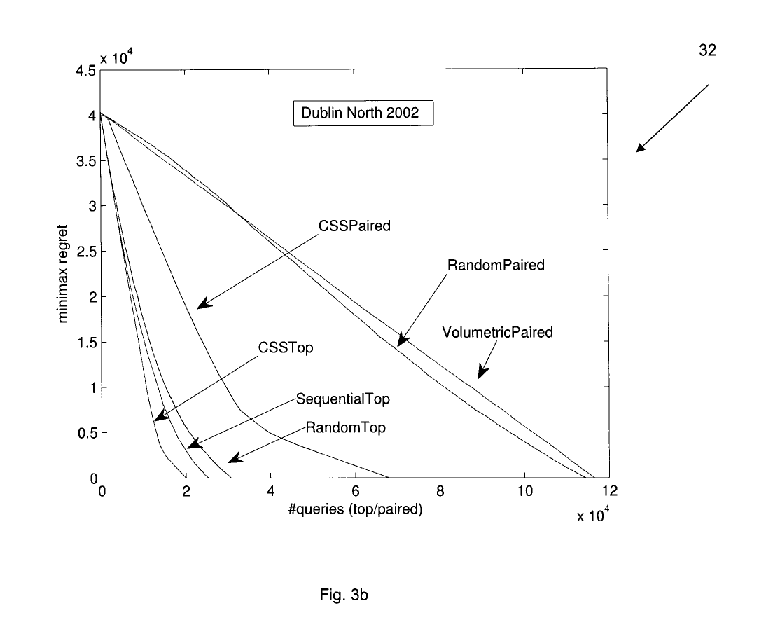

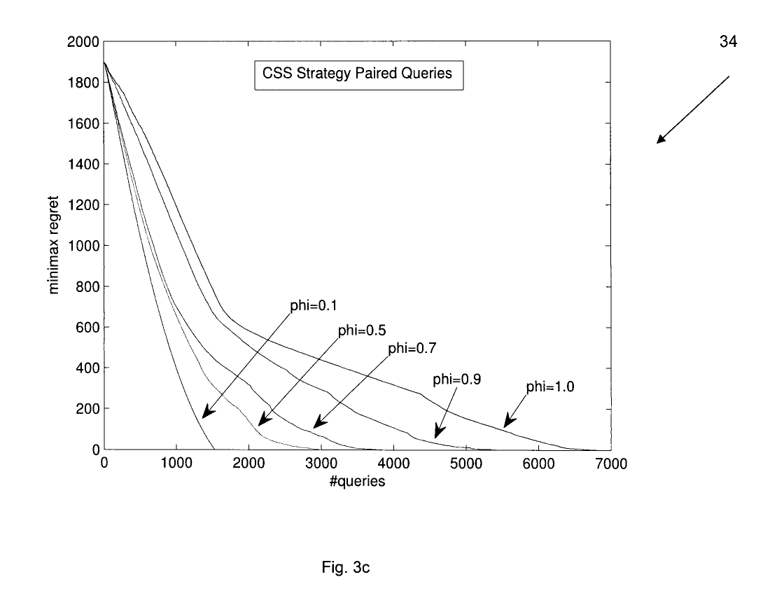

FIG. 3 shows data collected during experiments undertaken to test CSS on three datasets: (a) Sushi, 30 (See: T. Kamishima. H. Kazawa, and S. Akaho, “Supervised ordering: An empirical survey”, IEEE Intl. Conf on Data Mining, 673-676, 2005), with 5000 preference rankings over 10 varieties of sushi; (b) Irish, 32 with 2002 voting data from the Dublin North constituency, comprising 3662 rankings over 12 candidates (The data has 43,942 top-t ballots; 3662 are complete (i.e., t=12). See www.dublincountyreturningofficer.com); and (c) Mallows, 34 100 random rankings over 20 items generated from the Mallows preference model (See: C. L. Mallows, “Non-null ranking models”, Biometrika, 44:114-130, 1957). (Mallows is a distribution over rankings given by a modal ranking G and dispersion φε(0, 1] with Pr(r|σ, φ)αφ^{d(r,σ)} where d is Kendall's τ-distance. Smaller φ concentrates mass around σ, while φ=1 gives the uniform distribution.) These datasets were used to generate responses to elicitation queries, and span both political voting and recommender systems for consumer products.

CSS was tested on each data set, using both paired and top-t queries, assuming Borda voting (similar results may be expected to hold for other rules), and comparing it to the random and volumetric elicitation strategies on the two real-world sets. (Vol with top-t simply iterates sequentially through each voter, hence, is labeled SequentialTop). FIGS. 3a-3c show MMR as a function of the number of queries asked (both paired and top-t). On both Sushi data (as shown in FIG. 3a 30) and Irish data (as shown in FIG. 3b 32), CSS offers superior elicitation performance with both paired and top-t queries. With Sushi CSS reaches the optimal solution (i.e., the provable winner with MMR=0) after an average of only 11.82 paired queries per voter (cf. 20.64 for Vol, 20.63 for Rand, and 25 queries required by the theoretically optimal MergeSort to determine full voter rankings), and after 3.40 top-t queries per voter (cf. 4.18 for Seq, 5.50 for Rand). With Irish, results are similar: CSS reaches optimality with 18.57 paired and 5.47 top-t queries per user (cf. 31.82, 6.91 for VolISeq; 31.22, 8.38 for Rand, 33 for MergeSort). Critically, if one is interested in approximate solutions, that CSS may reduces MMR very quickly. For example, with Irish, CSS reduces MMR to 18% of its initial value (with no voter preference data) after only 5.82 paired queries per voter (cf. 25.77 for Vol, 24.03 for Rand), a small fraction of the queries required to elicit full rankings.

FIG. 3c shows performance of elicitation algorithms (paired and top queries) on Mallows data 34. On the synthetic Mallows set, 10 complete voter profiles were sampled for each value of 0 and CSS was run. With larger 0, more queries are clearly needed to reach the same level of regret, which conforms to intuitions that intelligent elicitation schemes can take significant advantage of less uniform preferences to minimize queries and voter effort (and conversely, that with almost uniformly random preferences, nearly full rankings must be obtained). Work in behavioral social choice strongly suggests that real-world preferences are not uniformly random (See: M. Regenwetter, B. Grofman, A. A. J. Marley, and I. Tsetlin, “Behavioral Social Choice”, Cambridge, 2006), and CSS performs especially well in this case; indeed the results on Sushi and Irish suggest that real preferences are not uniform, and contain regularities that can be readily exploited to reduce the informational complexity of voting.

The experiments examine the use of minimax regret as a means of robust winner determination to support the informational approximation of voting rules, as well as to guide the process of incremental elicitation of voter preferences. They demonstrate the tractability of regret computation for a collection of common voting rules, and demonstrate the power of regret-based elicitation on two real-world data sets and on synthetic data. Specifically, regret-based elicitation may allows a user, group or organization to determine both approximate and exact winners using only a small fraction of (pairwise) voter preferences.

Another example is provided to illustrate the incremental process for determining suggested group decisions. Let's say Alice, Bob, Christian, Dennis are deciding on where to go for vacation (Rome, Paris, Miami). Initially, the guarantee on all vacation locations (choices) are the same (low guarantee because no preference information is known). Then the system queries Bob, asking if whether he would choose Rome or Paris, Bob answers Rome. Now the guarantee on Rome improves a little. The system then goes to Dennis, asks whether he prefers Rome to Miami, Dennis says Rome. Guarantee on Rome improves further. Then system asks Christian whether he likes Rome over Paris, Christian answers Paris. The guarantee on Paris improves, guarantee on Rome stays the same. Then Christian is queried again asking if he likes Rome over Miami, he answers yes. Guarantee on Rome improves. Next Alice is queried what her top choice is, she answers Rome (this gives two pairwise comparisons: Rome preferred to Paris, and Rome preferred to Miami). Rome's guarantee improves significantly (e.g. 95% of optimal). The group looks at the guarantee>values of each vacation choice and sees that Rome has the best guarantee at 95% vs. 75% for Paris and 30% for Miami. They can either decide on Rome right now, or have the system ask one more person to get a 100% guarantee (Dennis would be asked if Rome is preferred to Paris, and he would answer yes).

It will be appreciated by those skilled in the art that other variations of the embodiments described herein may also be practiced without departing from the scope of the invention.

Other modifications are therefore possible.

### General System Implementation

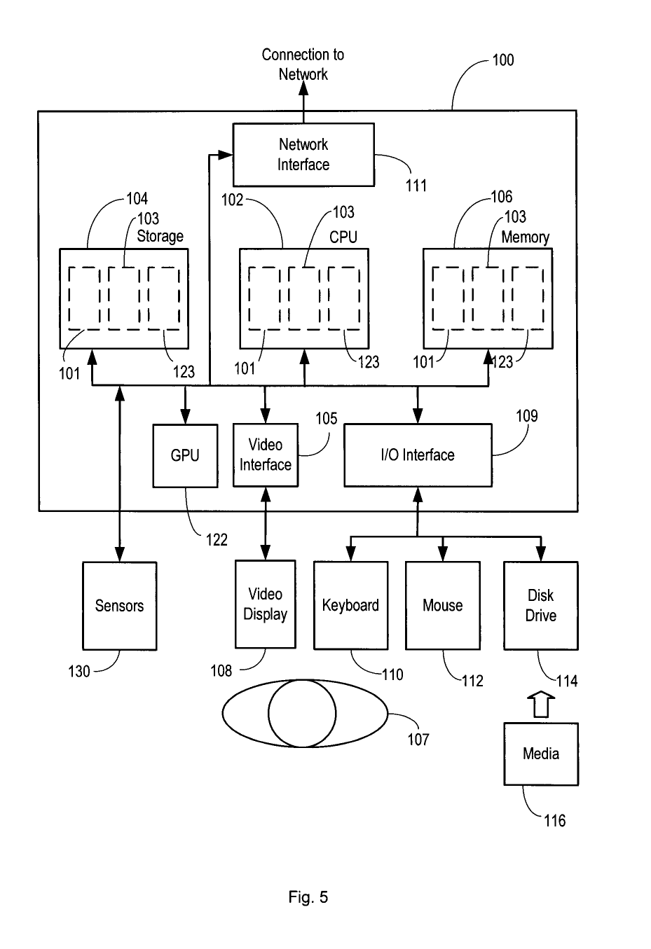

The present system and method may be practiced in various embodiments. A suitably configured computer device, and associated communications networks, devices, software and firmware may provide a platform for enabling one or more embodiments as described above. By way of example, FIG. 5 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

1. A computer network implemented system for suggesting a group decision, the system, characterized in that the system comprises:
(a) one or more server computers, connected to an interconnected network of computers, and linked to a server application;
(b) the server application includes or is linked to an intelligent voting manager that:
(i) receives as input a plurality of options over which a group of voters have certain preferences (“voter preferences”), and from which one or more options must be selected by the group of voters to establish the group decision;
(ii) receives as input information about the voting preferences of one or more voters for one or more of the plurality of options, wherein the voting preferences may relate to (A) all of the possible voting preferences given the plurality of options (“complete preference information”) or (B) a subset of the possible voting preferences given the plurality of options (“partial preference information”, complete preference information or partial preference information being “preference information”), wherein the voter preferences are expressible as pairwise preferences;
(iii) is configured to generate one or more suggested group decisions, whether the intelligent voting manager receives complete preference information or partial preference information, the suggested group decisions being generated based on the highest guaranteed level of group decision satisfaction relative to the received complete preference information or partial preference information, using the pairwise preferences; and
(iv) initiates the presentation of one or more suggested group decisions as output to the one or more voters.

2. The system of claim 1 wherein the system is operable to, including through one or more computers systems linked directly or indirectly to the system, (A) generate one or more queries for presentation to the one or more voters, wherein the queries are constructed to elicit preference information, and (B) receive one or more responses to the queries from the one or more voters that include complete preference information or partial preference information.

3. The system of claim 2, wherein the intelligent voting manager is operable to generate one or more quality or group satisfaction guarantees for the one or more suggested group decisions, and initiate the communication of the one or more quality or group satisfaction guarantees to the one or more voters.

4. The system of claim 3, wherein the system is operable to receive further preference information from one or more of the voters based on the communication of the one or more quality or group satisfaction guarantees.

5. The system of claim 4, wherein the intelligent voting manager is operable to generate further one or more quality or group satisfaction guarantees based on the preference information including the further preference information, and initiate the communication of the further one or more quality or group satisfaction guarantees to the one or more voters.

6. The system of claim 1, wherein the intelligent voting manager is configured to implement an incremental process wherein the one or more voters iteratively provide further preference information, and receive further quality or group satisfaction guarantees with improved levels as compared to levels associated with quality or group satisfaction guarantees for previously provided preference information, thereby incrementally improving quality or group satisfaction levels with the one or more suggested group decisions.

7. The system of claim 6, wherein the system is operable to receive a communication indicating that the one or more voters has accepted one or more suggested group decisions, and upon receipt of the communication the incremental process is concluded and the system is operable to log, or communicate to one or more computer systems linked to the system, the accepted decision.

8. The system of claim 1, wherein preference information, or a subset of preference information, is collected from one or more data sources linked to the system.

9. The system of claim 8, wherein the preference information includes preference information both input by the one or more voters and collected from one or more data sources.

10. The system of claim 8, wherein the preference information may include preference information extrapolated from one or more of online databases, product review websites, social networking websites, or “check-in” information from one or more location-aware applications or services.

11. The system of claim 6, wherein the incremental process further includes generating queries for one or more data sources linked to the system, and the system is adapted to generate the one or more suggested group decisions including based on the information provided by the one or more data sources in response to the queries.

12. The system of claim 1 wherein the one or more suggested group decisions are generated incrementally, the system generating one or more initial suggested group decisions and associated one or more quality or group satisfaction guarantees therewith, and then the system receiving further preference information and based on this further preference information the system generates further suggested group decisions and associated one or more quality or group satisfaction guarantees, where quality or group satisfaction levels of any further suggested group decisions are higher than the quality or group satisfaction levels of preceding suggested group decisions.

13. The system of claim 3 wherein the one or more quality or group satisfaction guarantees are expressed as one or more group satisfaction scores.

14. The system of claim 13, wherein the system is operable to generate a plurality of suggested group decisions and the associated group satisfaction score, and initiate the communication of such suggested group decisions and group satisfaction scores to the one or more voters.

15. The system of claim 3, wherein the one or more quality or group satisfaction guarantees are calculated by:
(a) measuring group satisfaction for the options using a voting rule that determines a group satisfaction score for each option, based on a ranking of all options by each voter; and
(b) determining a guaranteed level of group satisfaction for an option using maximum regret of that option relative to the group satisfaction measurement under (a) above.

16. The system of claim 15, wherein the one or more suggested group decisions are selected from possible group decisions based on the options that either (A) have minimal maximum regret, or (B) have maximum regret that it is within a predetermined factor of the plurality of options having minimal maximum regret.

17. The system of claim 13, wherein the intelligent workflow manager is operable to select particular one or more voters for whom if further preference information is obtained the group satisfaction scores can be improved.

18. The system of claim 1, wherein the intelligent workflow manager is further operable to determine particular preference information, which if obtained for one or more voters permits improvement of the group satisfaction scores.

19. A computer implemented method for generating one or more suggested group decisions, characterized in that the method comprises:
(a) receiving as input a plurality of options over which a group of voters have certain preferences (“voter preferences”), and from which one or more options must be selected by the group of voters to establish the group decision;
(b) receiving input information about the voting preferences of one or more voters for one or more of the plurality of options, wherein the voting preferences may relate to (A) all of the possible voting preferences given the plurality of options (“complete preference information”) or (B) a subset of the possible voting preferences given the plurality of options (“partial preference information”, complete preference information or partial preference information being “preference information”);
(c) logging the preference information as a set of pairwise preferences;
(d) generating one or more suggested group decisions using the pairwise preferences, whether the intelligent voting manager receives complete preference information or partial preference information, the suggested group decisions being generated based on the highest guaranteed level of group decision satisfaction relative to the received complete preference information or partial preference information; and
(e) initiating the presentation of one or more suggested group decisions as output to the one or more voters.

20. The method of claim 19, comprising the further step of generating one or more quality or group satisfaction guarantees and initiating the communication of these guarantees to the one or more voters.

21. The method of claim 20, wherein the receiving of input information about the voting preferences, and generation of one or more suggested group decisions and related quality or group satisfaction guarantees is an incremental process wherein the quality or group satisfaction guarantees for any subsequent suggested group decisions are improved over quality or group satisfaction guarantees for any previous suggested group decisions.
